(19) United States
(12) Patent Application Publication
(10) Pub. No.: US 2014/0067698 A1
(43) Pub. Date: Mar. 6, 2014

(54) DELIVERY SERVICE CARBON CALCULATOR

(71) Applicant: Richard W. Parlier, JR., Arlington, VA (US)

(72) Inventor: Richard W. Parlier, JR., Arlington, VA (US)

(21) Appl. No.: 13/601,673

(22) Filed: Aug. 31, 2012

(51) Int. Cl. G06Q 30/00

(52) U.S. Cl. CPC G06Q 30/018
USPC 705/317

(57) ABSTRACT

The present technology provides a carbon calculator that determines the emission of a delivery service sub-product and reports the emission to a user. The sub-product emission is determined from emission data and known cost data for products and sub-products over a period of time. A set of emission data for a delivery service for a previous period is attributed to the cost of the products provided by the delivery service during the period. The emissions may be source specific, such as fuel usage. The cost may be based on product cost per cost segment, mail volume, mail weight, labor hours, and other cost measurements. Once the product cost is known, a sub-product cost is determined from the product cost. Emissions for delivery sub-products may be reported using an emission calculator. Delivery sub-product emissions may also be reported as a statement covering a period of time.

### BACKGROUND OF THE INVENTION

Green house gases (GHG) include a variety of man-made air pollutants, such as carbon dioxide, chloroflourocarbons, methane and nitrogen oxides. GHGs act like a greenhouse to trap energy emitted from the ground to make the planet warmer. Reducing green house gases has become a topic of concern in recent years to avoid changing the climate of the Earth due to trapped sun energy.

Delivery companies have tried to provide information regarding GHG emissions corresponding to delivered packages. Typically, a package is associated with an emission based upon the distance traveled by the package, the package weight, and the mode of transportation by the package. These previous methods do not consider all relevant factors that contribute to the GHG produced by such a package. What is needed is an improved method for determining and reporting GHG for delivery of all mail.

### SUMMARY OF THE CLAIMED INVENTION

The present technology provides a carbon calculator that determines the emission of a delivery service sub-product and reports the emission to a user. The sub-product emission is determined from emission data and known cost and mail characteristics data for products and sub-products over a period of time. The emissions may be part of a fixed emission cost and a variable emission cost. A set of emission data for a delivery service for a previous period is attributed to product based upon the cost of the products provided by the delivery service during the period. The emissions may be source specific, such as fuel usage, and may need to be disaggregated using operational data, e.g., workhours, before they are attributed to product using cost data. Once the product cost is known, a sub-product emissions may be determined using sub-product cost and mail characteristic information. For example, once the emission due to priority mail products was determined, the emission due to a priority mailing sub-product may be determined—a priority mail piece that is transported three zones, weighing between three and four pounds. Hence, the sub-product is a particular instance of the product, with delivery information (zones travelled based on origin and destination) and mailing characteristics such as volume, weight, and type (flat, package). Emissions for delivery sub-products may be reported using an emission calculator. Delivery sub-product emissions may also be reported as a statement covering a period of time.

In an embodiment, emission data can be generated for delivery service products. A processor may execute a module to attribute a first emission stored in memory to two or more products delivered by a delivery company. Costs stored in memory and associated with two or more sub-products for at least one of the two or more products may be accessed. A processor may execute a module to attribute the product emissions to the two or more sub-products based on each sub-product cost to determine the emission for each of the two or more sub-products.

In an embodiment, emission data can be provided for a delivery service. One or more delivery sub-products associated with emission data may be identified. Each sub-product may correspond to a delivery class and specified destination. Emission data stored in memory and associated with each of the one or more delivery sub-products may be retrieved. A module stored in memory may be executed by a processor to provide emission data for each of the one or more delivery sub-products.

A system for automatically determining emissions due to a mailing may include a processor, a memory, and a data manager module, emission calculator module and user interface module stored in memory. The data manager module may be executed by the processor to retrieve sub-product emission data associated with one or more sub-products associated with a user. The emission calculator module may be executed by a processor to determine an emission associated with each of the one or more sub-products. The user interface module may be executed by the processor to report the emission associated with each of the one or more sub-products. The module may report emissions at a more aggregated level.

### BRIEF DESCRIPTION OF THE DRAWINGS

FIG. 1 is a block diagram of a system for providing emission data.

FIG. 2 is a block diagram of an application for providing emission data.

FIG. 3 is a method for reporting an emission.

FIG. 4 is a method for determining emissions for a delivery product.

FIG. 5 is a method for determining emissions for a delivery sub-product.

FIG. 6 is a method for reporting user emissions for a period of time.

FIG. 7 is a method for calculating an emission for sub-product.

FIG. 8 is a block diagram of a computing environment.

FIG. 9 is a block diagram of a mobile device.

### DETAILED DESCRIPTION

The present technology provides a carbon calculator that determines the emission of a delivery service sub-product and reports the emission to a user. The sub-product emission is determined from emission data and known cost and mail characteristics data for products and sub-products over a period of time. The emissions may be part of a fixed emission cost and a variable emission cost. A set of emission data for a delivery service for a previous period is attributed to product based upon the cost of the products provided by the delivery service during the period. The emissions may be source specific, such as fuel usage, and may need to be disaggregated using operational data, e.g., workhours, before they are attributed to product using cost data. Once the product cost is known, a sub-product emissions may be determined using sub-product cost and mail characteristic information. For example, once the emission due to priority mail products was determined, the emission due to a priority mailing sub-product may be determined—a priority mail piece that is transported three zones, weighing between three and four pounds. Hence, the sub-product is a particular instance of the product, with delivery information (zones travelled based on origin and destination) and mailing characteristics such as volume, weight, and type (flat, package).

Emissions for delivery sub-products may be reported using an emission calculator. A user may request the emission of a small number of delivery sub-products. The request may be received through a web page, mobile application, client application, or other portal. In response to the request, an emission calculator may retrieve the corresponding emission for the delivery sub-products and provide the emission data to the user.

Delivery sub-product emissions may also be reported for a period of time. A user may send multiple mailings using a delivery service over a period of time. The emissions corresponding to the mailings may be reported to the user in a report which outlines the different mailings or products used and corresponding emission data. The report may specify sub-product emissions as well as aggregated emission information. The report may be reported via a website, digital document, or other form periodically such as every year or every quarter or at other times, such as upon request.

The sub-product emissions may be determined and provided for a delivery service such as the United States Postal Service (USPS). However, the emission determination and reporting discussed herein is not intended to be limited to the USPS, and is intended to have a scope which extends to other delivery organizations.

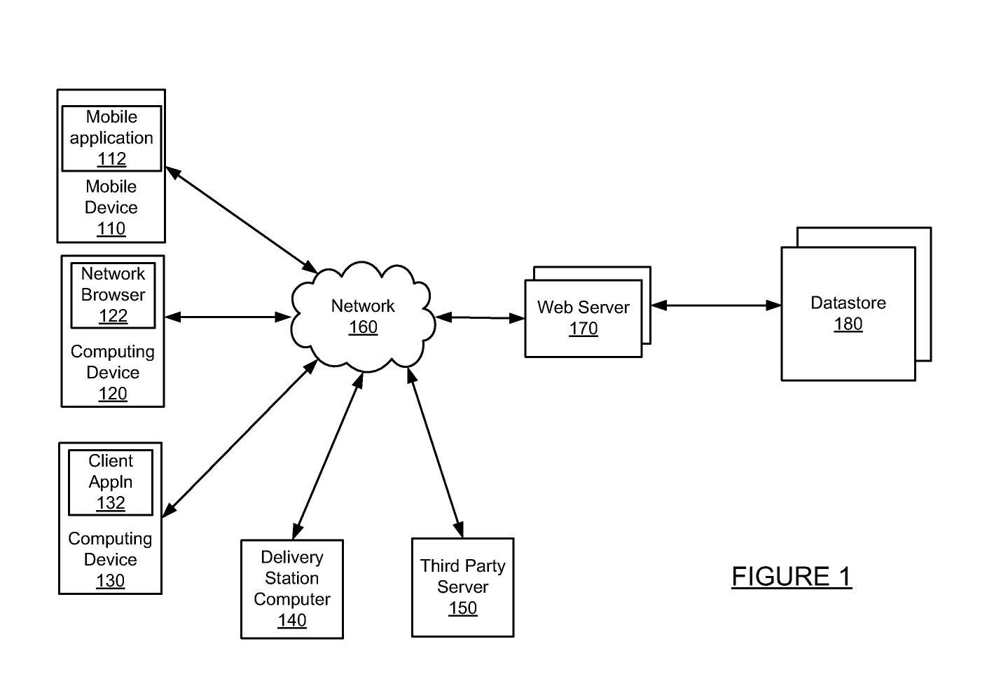

FIG. 1 is a block diagram of a system for providing emission data. The system of FIG. 1 includes mobile device 110, computing device 120, delivery station computer 140, and third party server 150. Each of the machines 110, 120, 130, 140 and 150 may communicate with web server 160 via network 170 to access sub-product emission data.

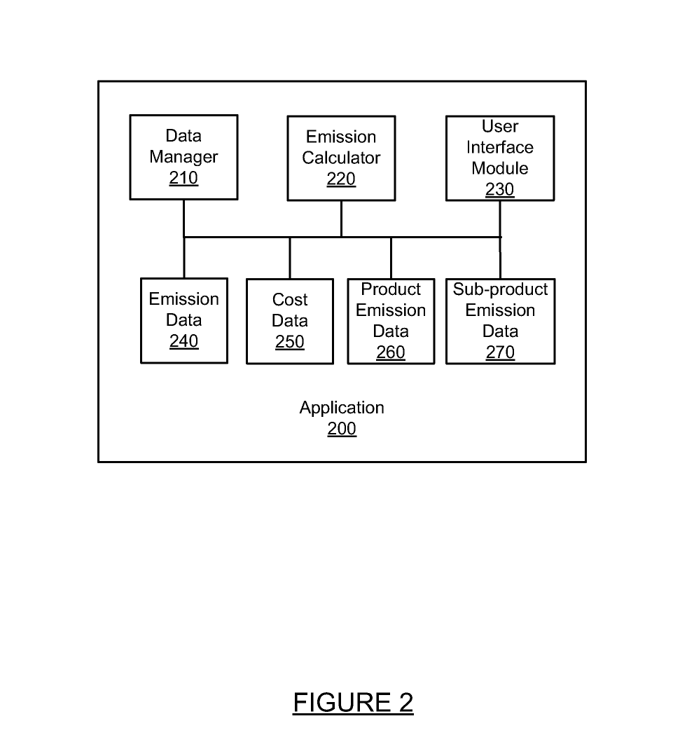

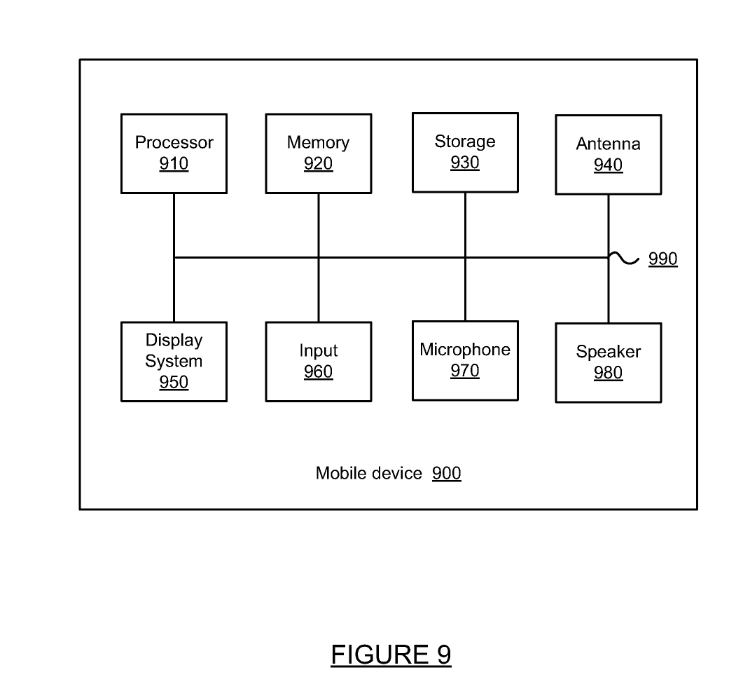

Mobile device 110 may be implemented as a smart phone, tablet computer or other mobile device. A mobile application 112 may be stored in memory of mobile device 110 and executable to provide emission data to a user of mobile device 110. Mobile application 112 may provide a sub-product mailing emission calculator or provides emission reports for a period of time for user sub-product mailings. Mobile application 112 is discussed in more detail with respect to FIG. 2. Mobile device 110 is discussed in more detail with respect to FIG. 9.

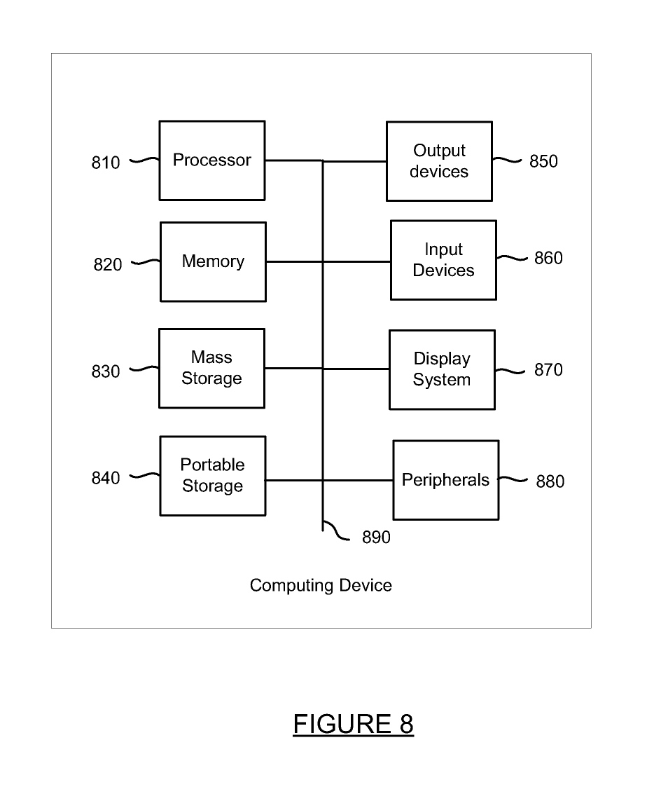

Computing device 120 may be implanted as a workstation, desktop computer, lap top, net book or other computing device and may retrieve and render web pages through network browser 122, stored in memory of computing device 120. Web server 170 may provide a web page that provides a sub-product mailing emission calculator or provides emission reports for a period of time for user sub-product mailings. The web page may be rendered through network browser 122 to allow a user of computing device 120 to determine sub-product emission data. Computing device 130 may include a client application stored in memory and executable by a processor to provide a sub-product mailing emission calculator or provide emission reports for a period of time for user sub-product mailings. Computing devices 120 and 130 are discussed in more detail below with respect to FIG. 8. Client application 132 is discussed in more detail with respect to FIG. 2.

Delivery station computer 140 may be implemented by a kiosk, workstation or other computer at a delivery service location, such as a United States Post Office station. The delivery station computer 140 may provide a sub-product mailing emission calculator or provide emission reports for a period of time for user sub-product mailings.

Third party server 150 may provide an emissions calculator or reporting mechanism for providing sub-product emission data for mailings provided by a delivery service. The third party service may be a partner or vendor or the delivery service, or otherwise have a relationship with the delivery service, such as the USPS, such that the third party may provide sub-product emission data.

Network 160 may communicate with mobile device 110, computing device 120, delivery station computer 140, third party server 150, and web server 170. Network 160 may include one or more intranets, extranets, a private network, a public network, the Internet, and any combination of these networks.

Web server 170 may be formed by one or more servers which handle requests received over network 160. The requests may be emission data for one or more sub-products, emission reports for one or more users or entities, or other data. Web server 130 receives requests, processes the requests by sending a request to datastore 180, receives a response from datastore 180 with the sub-product emission data and/or other information, and provides the sub-product emission data to the requesting device, such as one of devices 110-150.

Database 140 may include one or more data stores that communicate with the one or more web servers. In some embodiments, the datastores may also communicate directly with devices in communication with network 160. Datastore 180 may include all or a portion of emission data and cost data used to determine product and sub-product emissions, as well as the emissions for delivery products and delivery sub-products.

FIG. 2 is a block diagram of an application for providing emission data. The application may be implemented as a mobile device application, a client application, or other application including software executable by a processor on the device within the application resides.

Application 200 includes data manager 210, emission calculator 220, and user interface module 230. Data manager may communicate with remote devices and services to retrieve emission data 240 and cost data 250 for a delivery service. The emission data 240 may include GHG emissions by source from a previous period for the delivery service providing the sub-product emission information. The emission sources may include vehicle travel, emissions from refrigerant leakage from vehicles, facility emissions from natural gas, fuel oils and other oils, emissions from refrigerant leakage from facilities, indirect facility emissions and line losses from purchased electricity, indirect facility emissions from imported steam, highway contract route vehicles, employee owned rural route vehicles, air transport, rail transport, ship transport, employee business travel, wastewater treatment, solid waste disposal, and employee commuting. The data used to distribution emissions may include costs by product and sub-product for cost segments/components and mail characteristics information. For example, for the USPS, the products may include First-Class Mail, First-Class Package Services, Periodicals, Standard Mail, Package Services, Priority Mail, Express Mail, Parcel Select, Parcel Select Lightweight, and Parcel Return Service.

Emission calculator 220 may determine product emission data 260 and sub-product emission data 270 based on emission data 240 and cost data 250. Emission calculator may also determine an emission sum based on user entered sub-product information and sub-product emission data 270.

User interface module 230 may provide one or more interfaces for implementing a sub-product emission calculator, reporting emissions for sub-products over a period of time, and communicating other information. The interfaces may receive sub-product selections, dates to report emissions, and identify the user of application 200, such as for example by allowing a user to perform an account login.

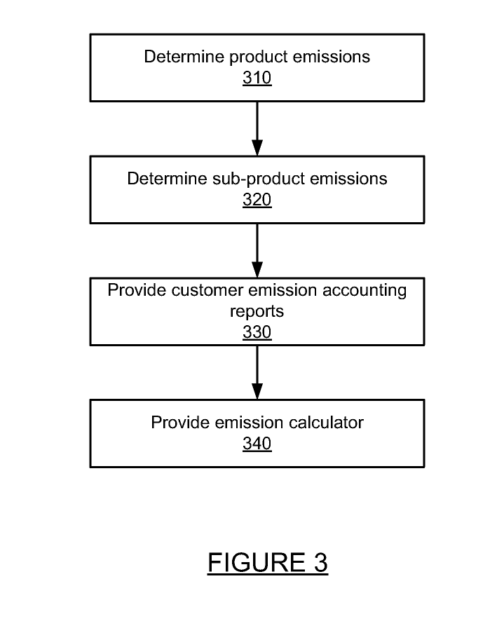

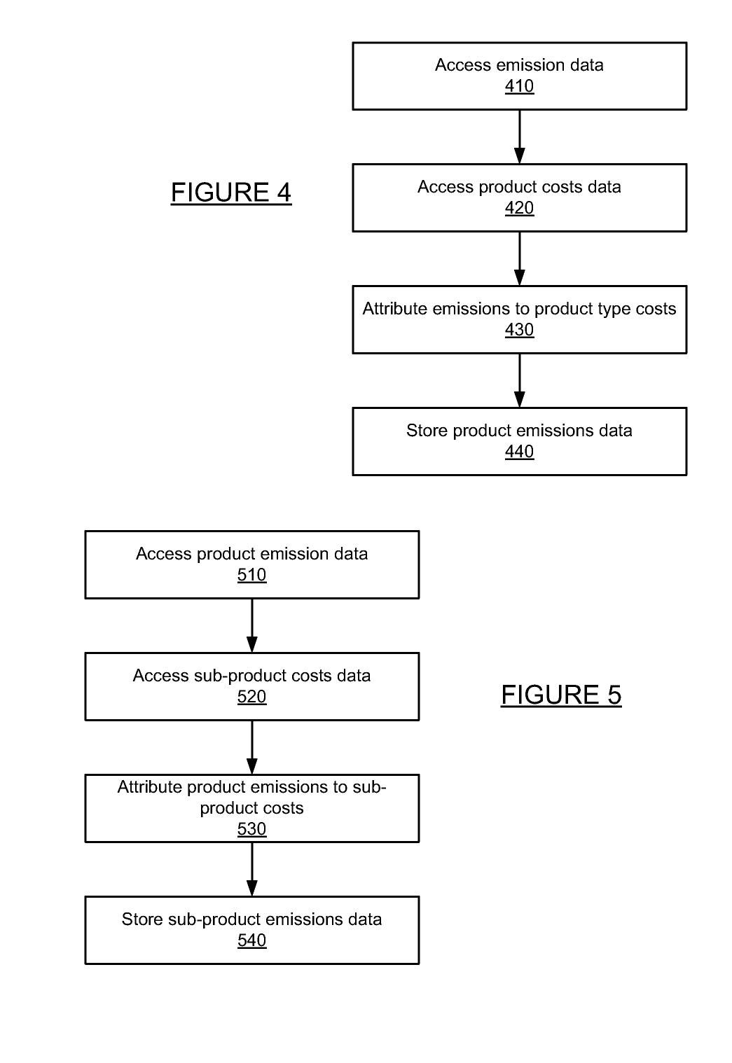

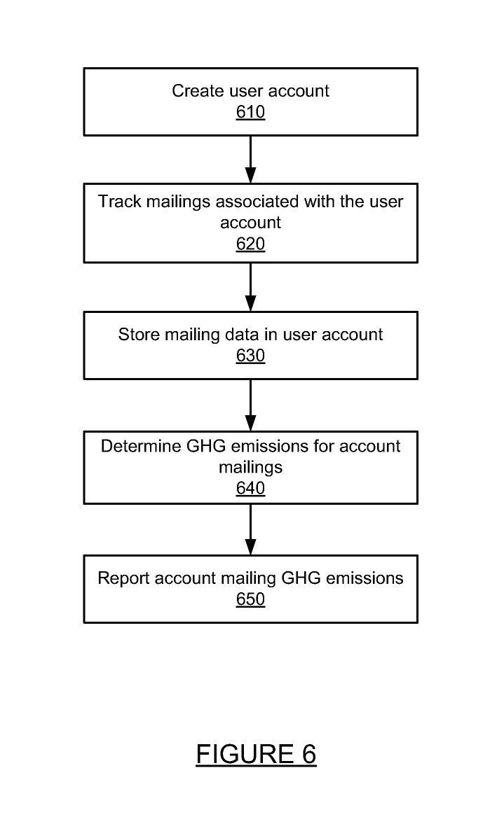

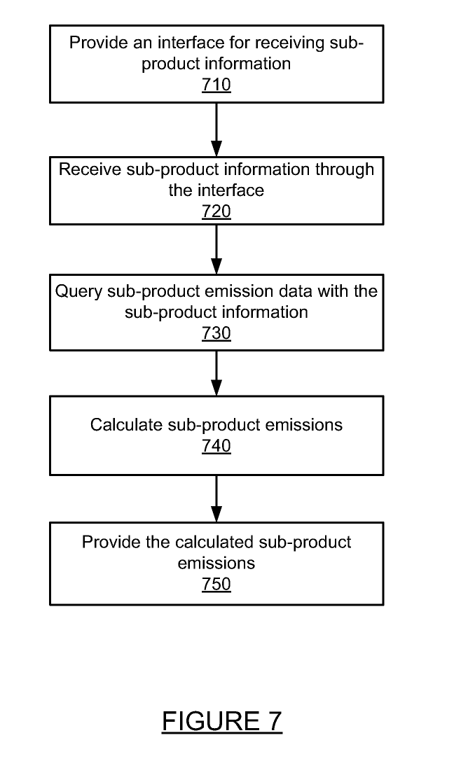

FIG. 3 is a method for reporting an emission. Product emissions are determined at step 310. Product emissions are determined from attributing GHG emissions to product using cost data for a period of time. Determining product emissions is discussed in more detail with respect to the method of FIG. 4. Sub-product emissions are determined at step 320. Determining sub-product emissions may include attributing each product emission to sub-product emission based on specific emission categories. Determining sub-product emissions is discussed in more detail with respect to FIG. 5. Customer emission accounting reports are provided at step 330. The reports may be provided to customers of the delivery service which purchase mailing products over a period of time. Providing customer emission accounting reports is discussed in more detail with respect to FIG. 6. An emission calculator is provided at step 340. The calculator may be provided through an application or web service, and may provide emissions for a mailing sub-product. Providing an emission product is discussed in more detail with respect to FIG. 7.

FIG. 4 is a method for determining emissions for a delivery product. Emission data is accessed at step 410. The emission data may include source-specific emission inputs such as vehicles, fugitive emissions from refrigerant leaks from the vehicles, employee commuting, business travel, wastewater treatment, and solid waste disposal, all for a specified period of time, such a fiscal year.

Product cost data may be accessed at step 420. The product cost data may include costs for delivery product mailings performed during a period of time corresponding to the emission data time period. Emissions are attributed to product at step 430. The distribution of emissions to product use product costs as distribution keys. Some emissions may be shifted from one product to another, such as to ensure consistency with delivery service costing methods. For example, emissions associated with delivery confirmation of products for which delivery confirmation is provided at no fee may be shifted. Product emission data is then stored at step 440.

FIG. 5 is a method for determining emissions for a delivery sub-product. Product emission data is accessed at step 510. The product emission data is the data created and stored in the method of FIG. 4. The product emission data may be identified as vehicle service driver emissions, transportation emissions, mail processing-related emissions, and other emissions.

Sub-product cost and mal characteristics data are accessed at step 520. With respect to the USPS, the sub-product data may include the cost breakdown of instances of First-Class Mail, First-Class Package Services, Periodicals, Standard Mail, Package Services, Priority Mail, Express Mail, Parcel Select, Parcel Select Lightweight, and Parcel Return Service products.

The product emissions data may be attributed to sub-product at step 530. Emissions may be applied to different products differently to determine the emissions of sub-products. When attributing emissions to Priority Mail sub-products, the emissions may be distributed equally on a per-piece basis except those related to transportation and vehicle service drivers (VSD). For transportation emissions, unit (per cubic foot and per pound) transportation costs by zone may be multiplied by the ratio of total Priority Mail transportation emissions to total Priority Mail transportation costs to develop unit (per cubic foot and per pound) transportation emissions by zone. These unit transportation emissions may be multiplied, respectively, by sub-product-specific average cubic feet and weight per piece to develop unit sub-product-specific transportation emissions. VSD emissions per cubic foot are determined by dividing total Priority Mail emissions by total Priority Mail cubic feet. To develop sub-product-specific VSD emissions, emissions per cubic foot are multiplied by sub-product-specific average cubic feet per piece.

The prices for some sub-products—e.g., Priority Mail flat rate and regional rate products, Commercial Plus Cubic—may not vary with weight. Rather, they may vary by type of flat/regional rate product or cube. Consistent with the pricing approach, emissions for these products are estimated based upon type of flat/regional rate product (e.g., padded envelope, medium flat rate box) or cube, not weight. Similarly and consistent with how they are priced, emissions for balloon and oversized sub-products are not estimated by weight increment.

When attributing emissions to Express Mail sub-products, the emissions may be distributed equally on a per-piece basis except for emissions related to transportation and VSD. Express Mail transportation costs are weight-related and may not vary by zone. Per-pound VSD/transportation emissions may be estimated by dividing total emissions by total Express Mail weight. To distribute these emissions to sub-product, these per-pound emissions may be multiplied by average weight per piece by weight increment.

Parcel Select and Parcel Return Service sub-product emissions may be distributed equally on a per-piece basis except for emissions related to transportation, VSD, and mail processing. Per cubic foot VSD/transportation costs by rate category (e.g., destination delivery unit) and, where applicable, zone are multiplied by the ratio of product-level VSD/transportation emissions to product-level VSD/transportation costs to develop VSD/transportation emissions per cubic foot by rate category and zone. To develop sub-product-specific emissions, these per-cubic foot transportation emissions are multiplied by average cubic feet per piece by weight increment. For Mail Processing emissions, per-piece mail processing costs may be multiplied by the ratio of total product-level mail processing emissions to product-level mail processing costs to develop per-piece emissions.

For First-Class Mail sub-products, emissions may be distributed equally on a per-piece basis except those related to transportation, VSD, and mail processing. VSD/transportation emissions per actual pound (as opposed to postage pound) may be calculated by dividing VSD/transportation emissions for the product by actual pounds. VSD/transportation emissions for a piece may be estimated by multiplying per-actual-pound emissions by the total number of actual pounds. Mail processing emissions are estimated by, where applicable, machinability, presort level, and presence of barcode. Mail processing emissions may be determined by multiplying sub-product-level per-piece mail processing costs by the product-level ratio of mail processing costs to mail processing-related emissions.

Emissions for Within-County Periodicals may be distributed equally on a per-piece basis except for those related to transportation and VSD. VSD/transportation emissions per non-DDU pound may be determined by dividing total VSD/transportation emissions by total non-DDU weight.

Outside-County Periodical emissions may be distributed equally on a per-piece basis except for emissions related to transportation, VSD, and mail processing. VSD/transportation emissions may be estimated per pound by multiplying per-pound VSD/transportation costs by entry point and zone by the product-level ratio of VSD/transportation emissions to VSD/transportation costs. Mail processing emissions may be estimated by multiplying detailed unit costs (for each non-weight price point) by the product-level ratio of mail processing emissions to mail processing costs.

Standard Mail emissions may be distributed equally on a per-piece basis except for emissions related to transportation, VSD, and mail processing. Per-pound VSD/transportation costs by entry point (origin, DNDC, DSCF, DDU) may be estimated for each product individually by subtracting per-pound destination entry VSD/transportation cost avoidances from the per-pound VSD/transportation cost of origin-entered Standard mail. To estimate per-pound emissions by entry point, per-pound VSD/transportation costs by entry point may be multiplied by the product-level ratio of VSD/transportation emissions to costs.

Note that destination entry VSD/transportation cost avoidances are estimated by shape. For products that are not shape-specific, the cost model associated with the product's primary shape is used in these calculations (e.g., the cost avoidances for flat-shaped mail are used for the Standard Mail Carrier Route product). Mail processing emissions are estimated, where applicable, by entry point, shape, machinability, presort level, and automation. Mail processing emissions may be estimated by multiplying sub-product-level costs by the product-level ratio of mail processing emissions to costs.

Emissions can be attributed to Package Service sub-products of single piece parcel post, bound printed matter, and media/library mail. Sub-product level emissions for single piece parcel post may be estimated using Parcel Select Nonpresort emission factors as proxies. The proxied emissions, however, are adjusted proportionally to align the weighted average emissions across all Single-Piece Parcel Post sub-products with product-level average emissions. Within a Bound Printed Matter product, emissions are distributed equally on a per-piece basis except for emissions related to transportation, VSD, and mail processing. Separately for flats and parcels, the model estimates VSD/transportation emissions per pound by multiplying per-pound VSD/transportation costs by entry point and zone by the shape-specific ratio of VSD/transportation emissions to VSD/transportation costs. Individually for flats and parcels, the model estimates mail processing emissions by multiplying sub-product-level unit costs (generally by entry point and whether the piece is Carrier Route presorted or not) by the product-level ratio of mail processing emissions to mail processing costs.

All Media/Library Mail emissions are distributed equally on a per-piece basis except for emissions related to transportation, VSD, and mail processing. The model estimates VSD/transportation emissions per pound by dividing total VSD/transportation emissions by total weight. The model estimates mail processing emissions by multiplying unit costs by presort level by the product-level ratio of mail processing emissions to mail processing costs.

The methods discussed for attributing product emissions to sub-product costs are exemplary, and not intended to be limiting. Other methods of attributing product emissions to sub-product, for example attributing product emissions to other types of sub-products, are considered within the scope of the invention.

After attributing product emissions to sub-product at step 530, the sub-product emissions data are stored at step 540.

FIG. 6 is a method for reporting user emissions for a period of time. A user account may be created with user account data at step 610. The user account data may be stored at database 160, and may include a username, password, company name, names of one or more people authorized to use the account, account number, contact information, preferences related to the delivery service and delivery service products.

Mailings associated with the user account are tracked at step 620. When someone associated with the account sends a mailing via a delivery service product, the account information may be provided to the delivery service (e.g., the USPS). The details of the mailing are stored with the account at step 630.

GHG emissions are determined for the account mailings at step 640. The calculation may be performed by multiplying sub-product level weight and volumes by sub-product level unit emission figures. The account mailings may span over a specified period of time, such as a fiscal year, a quarter, or some other time period. The account mailing GHG emissions may be reported at step 650. The reporting may be in the form of an accounting statement which lists the mailings performed/products used in association with the account, the individual emissions for each sub-product or product over the period of time, and other data. The report may be provided in the form of an electronic message, paper statement sent via post, or other manner.

FIG. 7 is a method for calculating an emission for sub-product. The method of FIG. 7 may be performed by an application or web service. An interface for receiving sub-product information is provided at step 710. The interface may be provided by a mobile application on a mobile device, a client application or network browser on a computing device, or a screen of a kiosk.

Sub-product information is received through the interface at step 720. The sub-product information may include information for a particular mailing (i.e., a sub-product) a user has sent or will send in the future. The sub-product emission data is queried for the sub-product information at step 730. The sub-product emission data for the sub-product information is received in response to the query, and sub-product emissions are calculated at step 740. Calculations may include multiplying particular sub-product emission values by the number and weight of mail pieces for each sub-product. The calculated sub-product emissions are provided at step 750. The sub-product emissions may be provided through an interface, within an electronic message, or some other reporting mechanism. The emissions may be provided in a report, statement or accounting based on categories, such as fixed and variable, and other groupings.

FIG. 8 illustrates a computing system 800 that may be used to implement a computing device for use with the present technology. System 800 of FIG. 8 may be implemented in the contexts of the likes of web server 130, datastore 140, and one or more of vendor devices 110-114. The computing system 800 of FIG. 8 includes one or more processors 810 and memory 820. Main memory 820 stores, in part, instructions and data for execution by processor 810. Main memory 820 can store the executable code when in operation. The system 800 of FIG. 8 further includes a mass storage device 830, portable storage medium drive(s) 840, output devices 850, user input devices 860, a graphics display 880, and peripheral devices 880.

The components shown in FIG. 8 are depicted as being connected via a single bus 890. However, the components may be connected through one or more data transport means. For example, processor unit 810 and main memory 820 may be connected via a local microprocessor bus, and the mass storage device 830, peripheral device(s) 880, portable storage device 840, and display system 880 may be connected via one or more input/output (I/O) buses.

Mass storage device 830, which may be implemented with a magnetic disk drive or an optical disk drive, is a non-volatile storage device for storing data and instructions for use by processor unit 810. Mass storage device 830 can store the system software for implementing embodiments of the present invention for purposes of loading that software into main memory 820.

Portable storage device 840 operates in conjunction with a portable non-volatile storage medium, such as a floppy disk, compact disk or Digital video disc, to input and output data and code to and from the computer system 800 of FIG. 8. The system software for implementing embodiments of the present invention may be stored on such a portable medium and input to the computer system 800 via the portable storage device 840.

Input devices 860 provide a portion of a user interface. Input devices 860 may include an alpha-numeric keypad, such as a keyboard, for inputting alpha-numeric and other information, or a pointing device, such as a mouse, a trackball, stylus, or cursor direction keys. Additionally, the system 800 as shown in FIG. 8 includes output devices 850. Examples of suitable output devices include speakers, printers, network interfaces, and monitors.

Display system 880 may include a liquid crystal display (LCD) or other suitable display device. Display system 880 receives textual and graphical information, and processes the information for output to the display device.

Peripherals 880 may include any type of computer support device to add additional functionality to the computer system. For example, peripheral device(s) 880 may include a modem or a router.

The components contained in the computer system 800 of FIG. 8 are those typically found in computer systems that may be suitable for use with embodiments of the present invention and are intended to represent a broad category of such computer components that are well known in the art. Thus, the computer system 800 of FIG. 8 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

FIG. 9 illustrates a mobile device system 900 that may be used to implement a mobile device for use with the present technology, such as for example in the contexts of the likes of one or more of vendor devices 110-114. The mobile device 900 of FIG. 9 includes one or more processors 910 and memory 960. Memory 960 stores, in part, programs, instructions and data for execution and processing by processor 910. The system 900 of FIG. 9 further includes storage 930, one or more antennas 940, a display system 950, inputs 960, one or more microphones 970, and one or more speakers 990.

The components shown in FIG. 9 are depicted as being connected via a single bus 990. However, the components 910-990 may be connected through one or more data transport means. For example, processor unit 910 and main memory 960 may be connected via a local microprocessor bus, and storage 930, display system 950, input 960, and microphone 970 and speaker 990 may be connected via one or more input/output (I/O) buses.

Memory 960 may include local memory such as RAM and ROM, portable memory in the form of an insertable memory card or other attachment (e.g., via universal serial bus), a magnetic disk drive or an optical disk drive, a form of FLASH or PROM memory, or other electronic storage medium. Memory 960 can store the system software for implementing embodiments of the present invention for purposes of loading that software into main memory 910.

Antenna 940 may include one or more antennas for communicating wirelessly with another device. Antenna 940 may be used, for example, to communicate wirelessly via Wi-Fi, Bluetooth, with a cellular network, or with other wireless protocols and systems. The one or more antennas may be controlled by a processor 910, which may include a controller, to transmit and receive wireless signals. For example, processor 910 execute programs stored in memory 960 to control antenna 940 transmit a wireless signal to a cellular network and receive a wireless signal from a cellular network.

Display system 950 may include a liquid crystal display (LCD), a touch screen display, or other suitable display device. Display system 970 may be controlled to display textual and graphical information and output to text and graphics through a display device. When implemented with a touch screen display, the display system may receive input and transmit the input to processor 910 and memory 960.

Input devices 960 provide a portion of a user interface. Input devices 960 may include an alpha-numeric keypad, such as a keyboard, for inputting alpha-numeric and other information, buttons or switches, a trackball, stylus, or cursor direction keys.

Microphone 970 may include one or more microphone devices which transmit captured acoustic signals to processor 910 and memory 960. The acoustic signals may be processed to transmit over a network via antenna 940.

Speaker 990 may provide an audio output for mobile device 900. For example, a signal received at antenna 940 may be processed by a program stored in memory 960 and executed by processor 910. The output of the executed program may be provided to speaker 990 which provides audio. Additionally, processor 910 may generate an audio signal, for example an audible alert, and output the audible alert through speaker 990.

The mobile device system 900 as shown in FIG. 9 may include devices and components in addition to those illustrated in FIG. 9. For example, mobile device system 900 may include an additional network interface such as a universal serial bus (USB) port.

The components contained in the computer system 900 of FIG. 9 are those typically found in mobile device systems that may be suitable for use with embodiments of the present invention and are intended to represent a broad category of such mobile device components that are well known in the art. Thus, the computer system 900 of FIG. 9 can be a cellular phone, smart phone, hand held computing device, minicomputer, or any other computing device. The mobile device can also include different bus configurations, networked platforms, multi-processor platforms, etc. Various operating systems can be used including Unix, Linux, Windows, Macintosh OS, Google OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for generating emission data for delivery service products, comprising:
executing a module stored in memory, the module executed by a processor to attribute a first emission stored in memory to two or more products delivered by a delivery company;
accessing costs stored in memory and associated with two or more sub-products for at least one of the two or more products; and
executing a module stored in memory, the module executed by a processor to attribute the product emissions to the two or more sub-products based on one or more of the sub-product costs to determine the emission for each of the two or more sub-products.

2. The method of claim 1, wherein the first emission includes an emission from each of two or more sources, and wherein product emissions are further attributed based on mail characteristic information.

3. The method of claim 2, wherein the sources include vehicle emissions, employee commuting emissions, business travel emissions, wastewater treatment emissions, and solid waste disposal emissions.

4. The method of claim 1, wherein the first emission is based on the cost of the two or more products.

5. The method of claim 4, wherein the product cost includes fuel data.

6. The method of claim 4, wherein the product cost includes employee work hours.

7. The method of claim 1, wherein the product emissions include vehicle service driver emissions, transportation emissions, and mail processing emissions.

8. The method of claim 1, wherein a portion of the product emissions are distributed to a sub-product equally on a per-piece basis.

9. The method of claim 1, wherein a portion of the product emissions are distributed to a sub-product based on zone of delivery for the sub-product.

10. The method of claim 1, wherein a portion of the product emissions are distributed to a sub-product based on average sub-product volume.

11. The method of claim 1, wherein a portion of the product emissions are distributed to a sub-product based on average sub-product weight.

12. A non-transitory computer readable storage medium having embodied thereon a program, the program being executable by a processor to perform a method for generating emission data for delivery service products, the method comprising:
attributing a first emission to two or more products delivered by a delivery company;
accessing costs associated with two or more sub-products for at least one of the two or more products; and
attributing the product emissions to the two or more sub-products based on each sub-product cost to determine the emission for each of the two or more sub-products.

13. The non-transitory computer readable storage medium of claim 12, wherein the first emission includes an emission from each of two or more sources.

14. The non-transitory computer readable storage medium of claim 31, wherein the sources include vehicle emissions, employee commuting emissions, business travel emissions, wastewater treatment emissions, and solid waste disposal emissions.

15. The non-transitory computer readable storage medium of claim 11, wherein the first emission is based on the cost of the two or more products.

16. The non-transitory computer readable storage medium of claim 15, wherein the product cost includes fuel data.

17. The non-transitory computer readable storage medium of claim 15, wherein the product cost includes employee work hours.

18. The non-transitory computer readable storage medium of claim 12, wherein the product emissions include vehicle service driver emissions, transportation emissions, and mail processing emissions.

19. The non-transitory computer readable storage medium of claim 12, wherein a portion of the product emissions are distributed to a sub-product equally on a per-piece basis.

20. The non-transitory computer readable storage medium of claim 12, wherein a portion of the product emissions are distributed to a sub-product based on zone of delivery for the sub-product.

21. The non-transitory computer readable storage medium of claim 12, wherein a portion of the product emissions are distributed to a sub-product based on average sub-product volume.

22. The non-transitory computer readable storage medium of claim 12, wherein a portion of the product emissions are distributed to a sub-product based on average sub-product weight.

23. A method for providing emission data for a delivery service, comprising:
identifying one or more delivery sub-products associated with emission data, each sub-product corresponding to a delivery class and specified destination;
retrieving emission data stored in memory and associated with each of the one or more delivery sub-products; and
executing a module stored in memory, the module executed by a processor to provide emission data for each of the one or more delivery sub-products.

24. The method of claim 23, wherein identifying includes receiving a request for the sub-product emission.

25. The method of claim 24, wherein the request is received through a web-page over a network.

26. The method of claim 24, wherein the request is received through a mobile application over a network.

27. The method of claim 23, wherein identifying includes retrieving one or more delivery sub-products delivered for an entity over a period of time.

28. The method of claim 23, wherein providing emission data includes providing the emission for a single sub-product based on a request.

29. The method of claim 23, wherein providing emission data includes providing a report of emissions for a plurality of sub-product delivered for an entity over a period of time.

30. A non-transitory computer readable storage medium having embodied thereon a program, the program being executable by a processor to perform a method for providing emission data for a delivery service, the method comprising:
identifying one or more delivery sub-products associated with emission data, each sub-product corresponding to a delivery class and specified destination;
retrieving emission data associated with each of the one or more delivery sub-products; and
to provide emission data for each of the one or more delivery sub-products.

31. The non-transitory computer readable storage medium of claim 30, wherein identifying includes receiving a request for the sub-product emission.

32. The non-transitory computer readable storage medium of claim 31, wherein the request is received through a web-page over a network.

33. The non-transitory computer readable storage medium of claim 31, wherein the request is received through a mobile application over a network.

34. The non-transitory computer readable storage medium of claim 30, wherein identifying includes retrieving one or more delivery sub-products delivered for an entity over a period of time.

35. The non-transitory computer readable storage medium of claim 30, wherein providing emission data includes providing the emission for a single sub-product based on a request.

36. The non-transitory computer readable storage medium of claim 30, wherein providing emission data includes providing a report of emissions for a plurality of sub-product delivered for an entity over a period of time.

37. A system for automatically determining postage pricing, comprising:
a processor;
a memory;
a data manager module stored in the memory and executed by the processor to retrieve sub-product emission data associated with one or more sub-products associated with a user;
an emission calculator module stored in the memory and executed by a processor to determine an emission associated with each of the one or more sub-products; and
a user interface module stored in the memory and executed by the processor to report the emission associated with each of the one or more sub-products.
